(19) United States
(12) Patent Application Publication
(10) Pub. No.: US 2004/0027329 A1
(43) Pub. Date: Feb. 12, 2004

(54) Method for providing display object and program for providing display object

(76) Inventor: Masahiro Nakamura, Tottori-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/416,165

(22) PCT Filed: Nov. 14, 2001
(86) PCT No.: PCT/JP01/09937

(30) Foreign Application Priority Data
Nov. 15, 2000 (JP) 2000-347407
Nov. 6, 2001 (JP) 2001-340341

(51) Int. Cl. G09G 5/00

(52) U.S. Cl. 345/156

(57) ABSTRACT

This is a system for providing a display object such as a three dimensional display object which is displayed on an image display unit by use of a computer or a computer network, and in which, aside from a control for generating an overall motion of the display object, a partial region in the display object is extracted and, in the partial region, a plurality of segmentation units are extracted, and, in response to a motion control instruction, each of the necessary segmentation units is moved based upon time lapse, and thereby, motion generation of the partial region is controlled, and it is possible to realize complicated motions and real motions, and it is possible to provide a high quality display object which can express emotions, intentions, characters and so on in an integrated manner.

### BACKGROUND OF THE INVENTION

1. Field of the Invention

This invention, in a technology of mainly three dimensional computer graphics and so on, relates to a display object such as a three dimensional object and so on which is displayed on a screen, and in particular, relates to a providing system of a display object which moves autonomously.

2. Description of the Related Art

In the past, to display a moving object on a display screen by a technology of computer graphics has been carried out, and such object is displayed on, for example, an image of a game software and a video image of a television to heighten an entertainment characteristic, or is used in, for example, a software which is used as a business tool and is utilized to heighten its expressive power and expediential characteristic.

As a technology relating to display of the above-described object, an autonomous personal avatar of JP-A-11-312159 is publicly known. The avatar is one which defines an outer appearance of an avatar and a scope of a motion and defines behaviors of an avatar and is formed by associating both sides, and for example, by having a control point fixed to a polygon moved in response to a start and a stop of a script which defines a behavior, the avatar is made to carry out a predetermined motion so that it becomes possible to personify a two dimensional avatar.

Also, as another publicly known technology, there is a three dimensional character animation display apparatus of JP-A-10-326353. The display apparatus is of such a structure that a three dimensional grid space is placed in a three dimensional space, and on the basis of three dimensional shape data and three dimensional motion data, a three dimensional object is placed in the three dimensional grid space, and for example, on the basis of the three dimensional motion data, hinge points are made to correspond to grid points, and a corresponding relation is changed to generate motions of the three dimensional character, and without using complicated physical data, the three dimensional character is easily generated and displayed.

Furthermore, JP-A-10-326353 discloses a three dimensional motion data transmission system in which disposed is a data transmission server which transmits any one and more of three dimensional grid space shape data, three dimensional shape data, texture data, and three dimensional motion data, and remaining data that the display apparatus does not transmit is held, and three dimensional motions of the three dimensional object is effectively generated and displayed by use of smaller parameters.

However, JP-A-11-312159 does not disclose a concrete structure for personifying the three dimensional object, and JP-A-10-326353, since it generates motions of the three dimensional display object by changing the corresponding relation of the hinge points and the grid points, is suitable to motion of a three dimensional object which was deformed in a simplified manner but it is difficult to have the three dimensional display object carry out complicated motion and real motions to display.

Also, in these years, individuation of demands of consumers and speed up of demand changing speed have been advanced, and it is sought that a display object with an individual specification which coincides with a preference of each user can be easily prepared and changed easily.

Also, in view of pending development of communication infrastructures which have become an issue in these years, also desired is such a mechanism in which information volume to be transmitted is reduced to the extent possible and a display object with high quality can be provided to a user.

This invention is one which suggests in order to solve the above-described problem, and aims to provide a providing system of a display object such as a three dimensional display object with high quality and so on which can carry out complicated motions and real motions and can express an emotion, an intention, a character and so on in an integrated manner.

Also, other object is to provide a providing system of a display object which can easily prepare a display object such as a three dimensional display object and so on with an individual specification which coincides with a preference of each user, and which also can change easily, and a capacity to an individualized demand and in which a demand environment change is excellent.

Also, other object is to provide a providing system of a display object which can provide a display object such as a three dimensional display object with high quality and so on, over reducing information volume to be transmitted to the extent possible.

### SUMMARY OF THE INVENTION

A providing method or a supplying system of a display object of the invention is a system of providing a display object which is displayed in a image display unit by use of a computer or a computer network, and characterized in that, aside from a control for generating an overall motion of the display object, a partial region in the display object is extracted and, in the partial region, a plurality of segmentation units are extracted, and, in response to a motion control instruction, each of the necessary segmentation units is moved based upon time lapse, and thereby, motion generation of the partial region is controlled. For example, in case that motions of the display object such as the three dimensional display object and so on which was human-shaped are generated, it is possible to make the overall motion physical motions of a human body, or the partial region or a human face or a predetermined region of a human face and so on. Also, it is possible to make the segmentation unit a coordinate or a predetermined group of coordinates. Motions of the partial region are prepared independently by a motion of the segmentation unit so that it becomes possible to generate a subtle facial expression, and, in cooperation with a change of a facial expression, and the facial expression and a physical motion of a human bogy, it is possible to express an emotion, an intention, and a character in an integrated manner.

Furthermore, a providing method of a display object of the invention is characterized in that, in the above-described providing method, stored are plural kinds of shape set data which define at least a structure and an outer appearance in which the display object can be moved, plural kinds of overall motions set data which are generated by a predetermined value that defined the overall motion of the display object in a chronological manner, and plural kinds of partial region motion set data which are generated by a predetermined value that defined the partial region motion of the display object in a chronological manner, and stored is at least one of a specific specification display object which comprises a combination of an extracted one of the shape set data, an extracted one of the overall motion set data and an extracted one of the partial region motion set data, and in response to a motion control instruction, a predetermined motion in the overall motion set data of the specific specification display object or in the partial region motion set data thereof or in both of them is extracted to be executed, and the motion of the specific specification display object is generated.

Furthermore, a providing system of a display object of the invention is characterized in that, in the above-described providing system, the motion control instruction is transmitted through a transmission medium.

Also, a providing system of a display object of the invention is a system of providing a display object which is displayed in an image display unit by use of a computer network, and is characterized in that a server stores plural kinds of shape set data which defines at least a structure and an outer appearance in which the display object can be moved, plural kinds of overall motions set data which are generated by a predetermined value that defined the overall motion of the display object in a chronological manner, and plural kinds of partial region motion set data which is generated by a predetermined value that defined the partial region motion of the display object in a chronological manner, and promotes downloading one or a plurality of the shape set data, one or a plurality of the overall motion set data, and one or a plurality of the partial region motion set data.

Furthermore, a providing system of a display object of the invention is characterized in that, in the above-described providing system, the server promotes setting the display object such as the three dimensional display object with a specific specification and so on which comprises a combination one of the shape set data, one of the overall motion set data, and one of the partial region motion set data.

Also, a providing system of a display object of the invention is a system of providing a display object which is displayed in an image display unit by use of a computer network, and is characterized in that a server transmits a motion control instruction to the specific specification display object of a user computer which comprises a combination of the shape set data which defines at least a structure and an outer appearance in which the display object can be moved, the overall motions set data which is generated by a predetermined value that defined the overall motion of the display object in a chronological manner, and the partial region motion set data which is generated by a predetermined value that defined the partial region motion of the display object in a chronological manner.

Furthermore, a providing system of a display object of the invention is characterized in that, in the above-described system, a server transmits a motion control instruction continuously or a continuous motion control instruction to a user computer which carries out processing in response to a motion control instruction. By transmitting the motion control instruction continuously or by transmitting the continuous motion control instruction by batch processing, real time motion generation is possible.

Furthermore, a providing system of a display object of the invention is characterized in that, in the above-described providing system, to the user computer which stored a program for generating a plurality of motions of the specific specification display object in parallel, the server transmits the motion control instruction which generates a plurality of motions in parallel by designating the specific specification display object which should be moved.

Furthermore, a providing system of a display object of the invention is characterized in that, in the above-described providing system, to the user computer which stored a program for independently generating a plurality of motions of the specific specification display object, the server transmits the motion control instruction which generates the motions by designating a plurality of the specific specification display objects which should be moved.

Furthermore, a providing system of a display object of the invention is characterized in that, in the above-described providing system, the server measures and stores information fee data to predetermined information which was transmitted to each user computer.

Also, a program for providing or supplying a display object of the invention is a program for providing a display object which is displayed in an image display unit by use of a computer or a computer network, and is characterized in that, aside from a control for generating an overall motion of the display object, a partial region in the display object is extracted and, in the partial region, a plurality of segmentation units are extracted, and, in response to a motion control instruction, each of the necessary segmentation units is moved based upon time lapse, and thereby, motion generation of the partial region is controlled.

Also, a program for providing a display object of the invention is characterized in that, to a specific specification display object such as a three dimensional object which comprises shape set data which defines at least a structure and an outer appearance in which the display object can be moved, overall motions set data which is generated by a predetermined value that defined the overall motion of the display object in a chronological manner, and partial region motion set data which is generated by a predetermined value that defined the partial region motion of the display object in a chronological manner, and, in response to a motion control instruction, a predetermined motion in the overall motion set data of the specific specification display object or in the partial region motion set data thereof or in both of them is extracted to be executed, and the motion of the specific specification display object is generated.

The above-described program can be stored in a recording medium such as CD-ROM and distributed, and can be transmitted through a transmission medium such as a communication line such as an optical fiber etc. and wireless.

Also, the above-described motion control instruction may be generated by for example, converting voice sounds, and by transmitting the motion control instruction prepared by converting the voice sounds to a user computer, it is possible to make live voice sounds generated motions of a real time display object and to provide the same to a user. In addition, the above-described providing system of the display object and the program can be changed or added properly, and it is possible to adopt or change the above-described each structure of the invention for the above-described other structure of the invention.

Also, in the invention, a server A which stores the shape set data which defines at least a structure and an outer appearance in which the display object such as a three dimensional object can be moved, the overall motions set data which is generated by a predetermined value that defined the overall motion of the display object in a chronological manner, and the partial region motion set data which is generated by a predetermined value that defined the partial region motion of the display object in a chronological manner, and a server B which transmits the motion control instruction may be the same server or may be a plurality of different servers, and, by adopting the different servers, it becomes possible to separate a specialized business party which defines a shape of the display object and possible motions from a specialized business party such as a scenario editor which prepares and transmits the motion control instruction, and provide advanced services which support the needs of users with regard to motion generation of the display object.

Furthermore, a server α which stores the shape set data which defines at least a structure and an outer appearance in which the display object can be moved, a server β which stores the overall motions set data which is generated by a predetermined value that defined the overall motion of the display object in a chronological manner, and a server γ which stores the partial region motion set data which is generated by a predetermined value that defined the partial region motion of the display object in a chronological manner may be disposed as different servers, respectively, and the shape set data, the overall motion set data, the partial region motion set data, and the motion control instruction can be combined properly and provided by the same server or a plurality of the different servers. In addition, the user computer can be provided as one computer or a plurality of computers as a matter of course.

Also, a providing system or a providing method of a display object such as a three dimensional object etc. of the invention is a system for generating a motion of a display object which is displayed in an image display unit by use of a computer network and for providing the display object, and is characterized in that, on the basis of a motion request having a motion object of the display object which is set, a motion content of the motion object and motion time, generated is a unit motion request which is comparable to a unit time portion of a motion of the motion object, and to the user computer which has a unit adapted to recognize the motion object, executes the unit motion request by the motion time portion and generates the motion of the motion object, at least a server transmits the motion request. As the motion content of the motion request, it is, for example, a movement to a predetermined point and the unit motion request of its motion request is generated and the motion object is recognized, and the unit motion request is executed by the motion time portion and the motion object is moved to the predetermined point.

Furthermore, a providing system of a display object of the invention is characterized in that, on the basis of another motion request having another motion object and another motion content and another motion time, to the above-described user computer having a unit adapted to generate another unit motion request, and recognize the another motion object, and execute the another unit motion request by predetermined number of times in parallel with the another motion time portion at the same time to generate a motion of the another motion object, at least the above-described server transmits the motion request.

Furthermore, a providing system of a display object of the invention is characterized in that, on the basis of a plurality of motion requests to which information being capable to distinguish parallel processing and sequential processing is added according to need, to the above-described user computer having a unit adapted to process each motion request in parallel in case of a plurality of the motion requests of parallel processing, and to process each motion request sequentially in case of a plurality of motion requests of sequential processing, at least the above-described server transmits a plurality of the motion requests.

Furthermore, a providing system of a display object of the invention is characterized in that, the above-described server transmits the motion request to the above-described user computer having a unit adapted to store the motion requests, and in addition to generating the motion of the motion object on the basis of the motion request to be stored, generated is a motion of the motion object on the basis of the motion request to be transmitted. By generating the motion of the display object by the motion request that the server transmits separately, in addition to the motion request which is stored in the user computer, it is possible to improve an entertainment character and so on by generation etc. of motions of the display object which a user does not guess ahead, and also, it becomes possible to transmit desired information from the server side through the motion which is generated by the display object.

Furthermore, a providing system of a display object of the invention is characterized in that the server transmits data of the display object to the user computer, in response to a transmission request. By transmitting the data of the display object such as for example, partial or overall shape or motion structure etc., in response to the transmission request of the user computer, it becomes possible for a user to utilize or set properly a desired display object according to his/her preference, and its entertainment characteristic etc. are improved.

Also, a providing system of a display object of the invention is a system for generating a motion of the display object which is displayed in an image display unit by use of a computer network and for providing the display object, and is characterized in that, to a user computer having a unit adapted to generate a motion of the display object which is set on the basis of motion data, a server transmits motion data, and in addition to generation of a motion based upon the motion data which is set in the user computer, provided is generation of a motion of the display object based upon the motion data which is transmitted. The motion data such as the motion request is set properly, and a timing for transmitting the motion data and generating the motion is set properly. In addition to the motion generation of the motion data which is set, for example, by having generation of a motion of the display object occur by the motion data which is transmitted in parallel, a motion of the display object which is impossible to be guessed ahead and a more desirable motion are generated so that it is possible to improve diversity and an entertainment characteristic.

Also, a providing system of a display object of the invention is a system for providing a display object which is displayed in an image display unit and which motions are generated by use of a computer network, and is characterized in that, to a user computer having a unit adapted to store the display object which is set, and to generate a unit motion request which is comparable to a unit time portion of the motion of a motion request on the basis of a motion request having a motion object of the display object and a motion content of the motion object and motion time, and to recognize the motion object and to execute the unit motion request by the motion time portion to generate the motion of the motion object, at least a server transmits a part or all of data of the display object. As to the data of the display object which is transmitted, data of outer appearance, data of movable structure or combination of them and soon are set properly, and it is possible to transmit data relating to all or a part of the display object which is set in the user computer. By the above-described structure, it is possible to provide the display object which meets preference of a user so that the entertainment characteristic can be improved, and by charging a fee to the data etc. of the display object which was provided, it is possible to realize a business for providing display objects.

Since the providing system etc. of the display object such as the three dimensional display object etc. is of the above-described structure, obtained are advantages that it is possible to make the three dimensional object which is provided high quality one by which a complicated motion and a real motion can be possible, and it is possible to express an emotion, an intention, a character and so on in an integrated manner.

Also, the providing system etc. of the display object of the invention, by the above-described structure, can provide advantages that it is possible to prepare or change easily a three dimensional object with an individual specification which meets a preference of each user, and an excellent correspondence to an individualized demand and a demand environment change can be exerted.

Also, the providing system etc. of the display object of the invention, by the above-described structure, can provide an advantage that it is possible to provide the display object such as high quality three dimensional object etc. to a user over reducing information volume to the extent possible.

Furthermore, it is possible to provide a motion generation service of the display object which meets a preference of a user and is of high quality, by the motion control instruction which is properly transmitted by the server.

Also, by the providing system etc. of the display object such as the three dimensional display object etc. of the invention, it is possible to generate complicated and advanced motions of the display object such as the three dimensional object etc., for example, to generate a plurality of motions of the three dimensional object which is displayed by a computer graphics independently and in parallel, or to generate motions of a plurality of three dimensional objects independently and in parallel, or to generate a plurality of motions of each three dimensional object independently and in parallel at the same time, and it is possible to generate motions of the display object which can not be guessed ahead, or it is possible to freely combine motions along a plurality of scenarios. Accordingly, it has an advantage that high needs of a user to a rich content, reality and entertainment characteristic can be satisfied.

### BRIEF DESCRIPTION OF THE DRAWINGS

FIG. 1 is a block diagram showing a hardware structure in a display object providing system of a first embodiment;

FIG. 2 is a flowchart showing an entire flow in the display object providing system of the first embodiment;

FIG. 3 is a view showing content examples of shape set data, overall motion set data, partial region motion set data relating to the first embodiment;

FIG. 4 is a view showing an example of a human-shaped three dimensional object relating to the first embodiment;

FIG. 5 is a view showing an example of a motion control instruction of the three dimensional object relating to the first embodiment;

FIG. 6 is a flow chart showing a flow for generating an overall motion in the three dimensional object in the first embodiment;

FIG. 7 is a flow chart showing a flow for generating a partial region motion in the three dimensional object in the first embodiment;

FIG. 8 is a block diagram showing a hardware structure in a display object providing system of a second embodiment;

FIG. 9 is an illustration illustrating processing for generating a motion of a three dimensional object in the second embodiment;

FIG. 10 is an illustration illustrating a flow for executing a motion request in the second embodiment;

FIG. 11 is a view showing a motion request at a first example in the second embodiment;

FIG. 12 is an illustration illustrating a motion for generating in response to the motion request at the first example in the second embodiment;

FIG. 13 is a view showing a second example of the motion request in the second embodiment; and

FIG. 14 is an illustration illustrating a motion for generating according to the motion request of the second example in the second embodiment.

### DESCRIPTION OF THE PREFERRED EMBODIMENTS

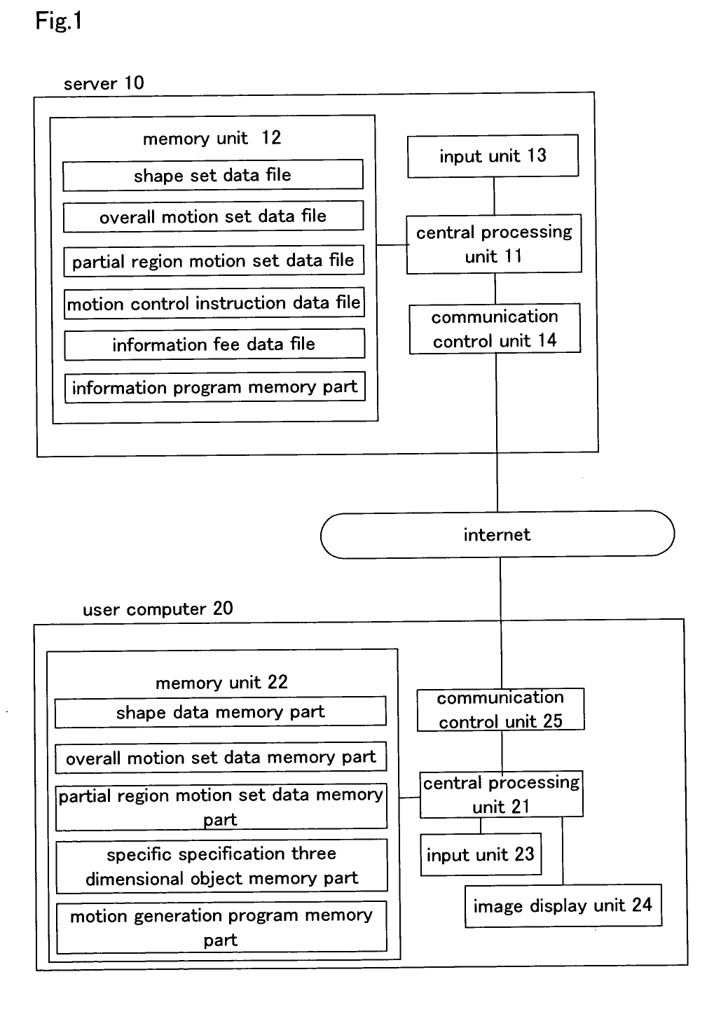

Hereinafter, concrete embodiments of a display object providing system of the invention will be described but this invention is not limited to such embodiments. FIG. 1 is a block diagram showing a hardware structure of a display object providing system of a first embodiment of the invention.

The providing system of the display object of the first embodiment is one which provides a three dimensional display object, and its hardware structure is, as shown in FIG. 1, such that a server 10 and a user computer 20 is connected through the Internet, and on the basis of data which the server 10 provides through the Internet, the three dimensional object is displayed in the user computer 20, and its motions are generated. In addition, the server 10 and the user computer 20 may be connected by other communication network than the Internet and a network of LAN, and it is fine if computers are connected to one another.

In the server 10, a central processing unit 11 having CPU etc., a memory unit 12 such as RAM, ROM etc., an input unit 13 such as a keyboard, a mouse etc., and a communication control unit 14 are disposed by being connected, and in the memory unit 12, disposed are memory parts which store necessary data etc. such as a shape set data file which stores plural kinds of shape set data, an overall motion set data file which stores plural kinds of overall motion set data, a partial region motion set data file which stores plural kinds of partial region set data, a motion control instruction data file which stores motion control instruction data, an information fee data file which stores fee data for provided information, and an information providing program memory part which stored a program of controlling overall motions for providing information to a user 20. The above-described each data etc. can be added, deleted, changed and so on by the input unit 13.

In the user computer 20, a central processing unit 21 having CPU etc., a memory unit 22 such as RAM, ROM etc., an input unit 23 such as a keyboard, a mouse etc., an image display unit 24 such as a display, a liquid crystal panel etc. and a communication control unit 25 are disposed by being connected, and in the memory unit 22, provided are memory parts which stores necessary data etc. such as a shape data memory part which stores one kind or plural kinds of shape set data, an overall motion set data memory part which stores one kind or plural kinds of over all motion set data, a partial region motion set data memory part which stores one kind or plural kinds of partial region motion set data, a specific specification three dimensional object memory part which stores a three dimensional object with a specification which was set by a user, a motion generation program memory part which carries out control of overall motions for generating motions of the three dimensional object based upon each data, and another memory part which stores a program of realizing three dimensional virtual space. The above-described each data etc. can be added, deleted, changed and so on by the input unit 23. In addition, it is possible to provide a plurality of user computers 20 which receive information services from the server 10 as a matter of course.

The above-described motion generation program includes a program of carrying out a plurality of motions in parallel at the same time, in case that provided is a motion control instruction for carrying out a plurality of motions which will be described later at the same time, and it is possible to have the three dimensional object carry out a composite motion. Furthermore, it also includes a program of having a different three dimensional object carry out a different motion, a composite motion independently, and it is possible to have the different three dimensional object carry out the different motion, composite motion independently in response to the motion control instruction.

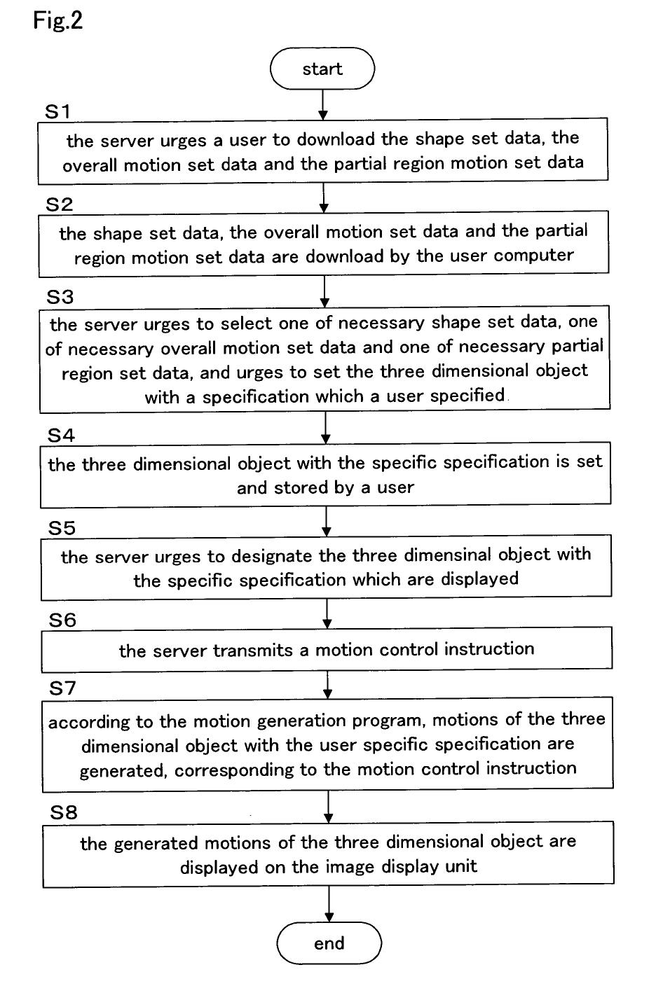

An entire flow of providing the three dimensional object which is carried out by the above-described hardware structure is shown in the flow chart of FIG. 2. On the assumption, an identification ID which was inputted from a user is judged by the server 10 so that confirmation of the identification ID is carried out. And, firstly, by processing of the central processing unit 11 along the information providing program, the server 10 urges a user to select and download at least one by one from each data, plural kinds of which are stored in each data file, such as the shape set data, the overall motion set data and the partial region motion set data, through the image display unit 24 of the user computer 20 (S1), and selected each data is extracted and the shape set data, the overall motion set data and the partial region motion set data are downloaded by the user computer 20 (S2). The downloaded shape set data, the overall motion set data and the partial region motion set data are stored and memorized in the shape set data memory part, the overall motion set data memory part, and the partial region motion set data memory part of the user computer 20, respectively.

Then, the server 10 urges to select, out of one kind or plural kinds of the downloaded shape set data, the overall motion set data and the partial region motion set data, one of necessary shape set data, one of necessary overall motion set data and one of necessary partial region set data, and urges to set the three dimensional object with a specification which a user specified (S3). In response to this, a user selects one of necessary shape set data, one of necessary overall motion set data and one of necessary partial region set data, and sets at least one three dimensional object with the specific specification which was set, and the three dimensional object with the specific specification which was set is stored in a specific specification three dimensional object memory part of the memory unit 22 (S4).

Then, autonomously or in response to a request from the user computer 20, the server 10 urges a user to designate one or a plurality of the three dimensional objects with user specific specification which are displayed on the image display means 24 through the image display unit 24 (S5), and a user designates the three dimensional object with the specific specification which is used, and the designated three dimensional object is set in a memory or another memory part in the central processing unit 21. And, the server 10 transmits a motion control instruction of the three dimensional object to the user computer 20 (S6).

Furthermore, by processing of the central processing unit 21 according to the motion generation program, in response to the motion control instruction which was transmitted, processing of the overall motion set data and the partial region motion set data which correspond to the motion control instruction of the three dimensional object with the user specific specification is carried out so that motions of the three dimensional object with the user specific specification are generated for a predetermined period of time which was set in each data (S7). The generated motions of the three dimensional object are to be displayed on the image display unit 24 (S8).

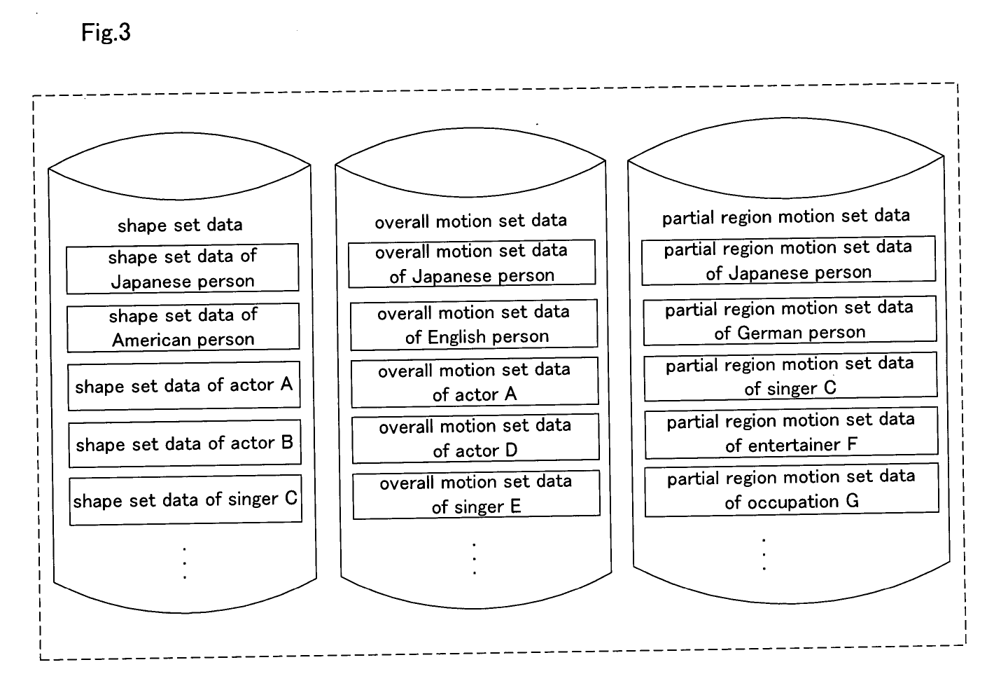

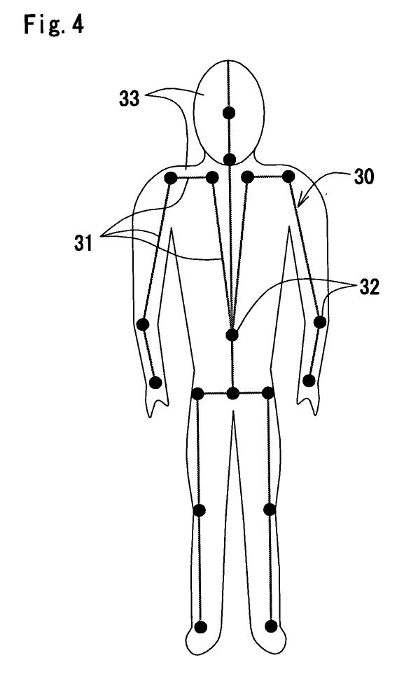

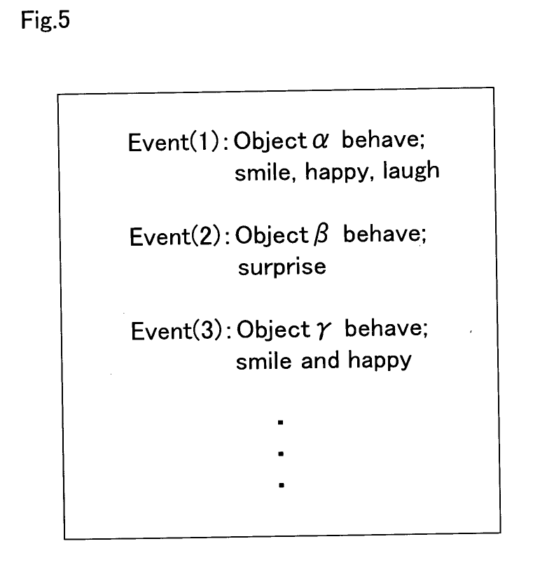

Here, contents of the shape set data, the overall motion set data, the partial region motion set data, and the motion control instruction data will be described. FIGS. 3 to 5 relate to the first embodiment, and FIG. 3 is a view showing content examples of the shape set data, the overall motion set data, and the partial region motion set data, and FIG. 4 is a view showing an example of a human-shaped three dimensional object, and FIG. 5 is a view showing an example of the motion control instruction of the three dimensional object.

The shape set data is data in which an outer appearance of the three dimensional object, a pattern, color and so on which answered the need are made to be one set, and for example, as shown in FIG. 3, it is possible to set in such a manner as shape set data of an average Japanese person, shape data of an actor A and so on. A structure which can make the three dimensional object in this embodiment move is a skeleton structure 30 as shown in FIG. 4, and the skeleton structure 30 is a structure in which parts 31 which are bones at each portion such as arms, a middle, legs and so on are linked through hinge points 32, and is of such a structure that, by determining an angle of each hinge point 32 by a three dimensional local coordinate system with setting an end point of a higher ranking part 31 at an original point, a direction of each part 32 is determined, and the skeleton structure 30 moves.

Data which defines the outer appearance etc. of the three dimensional object comprises a structure that, at a necessary position of the three dimensional local coordinate system which defines the skeleton structure 30 with setting, for example, a predetermined hinge point 32 as the original point, polygon data etc. are set by curved lines and curved surfaces, and to this, a necessary outer appearance, patterns, colors etc. such as images etc. of a face and clothes were attached by the texture mapping. In addition, a structure of the shape set data of each set can be set properly besides the above-described one. Also, the hinge point 32 of the original point which defines the three dimensional local coordinate system may be set as a representative point on the occasion of moving the three dimensional object which will be described later by the overall motion. Also, data of the outer appearance etc. of the three dimensional object can be obtained by utilizing CG, CAD etc. which can make a three dimensional measurement machine and a three dimensional shape.

The overall motion set data is data which defines the overall motion of each three dimensional object, and for example, in case that a motion control instruction for carrying out the overall motion of surprise, data which defines the overall motion of its surprise, and a plurality of motion contents such as surprise, pleasure, sadness and so on are set with respect to each set. The overall motion is, in case that the three dimensional object is a human, one which is comparable to physical motions of a human body, and for example, as shown in FIG. 3, it is possible to set up a set which directly corresponds or does not correspond to the shape set data, in such a manner as the overall motion set data of an average Japanese person, the overall motion set data of a singer E and so on.

The overall motion set data of this embodiment is one which defined the angle of each hinge point 32 of the skeleton structure 30 in a chronological manner, and is of such a structure that, the angle of the necessary hinge point 32 is changed in response to the data for a predetermined period of time such as several seconds and so on and thereby, the three dimensional object carries out predetermined overall motions. In addition, besides the above-described angle, the overall motion may be defined by a position of each hinge point 32 in the three dimensional local coordinate system which defines the skeleton structure 30. Also, data relating to the overall motion can be obtained by a motion capture and so on.

The overall motion set data includes data which defines a chronological moving distance and its moving direction of the three dimensional object, according to need, and the data is defined by for example, a displacement vector or affine transformation and so on, and a representative point such as a predetermined hinge point 32 and so on of the three dimensional object is extracted, and the representative point is moved with a predetermined distance in a predetermined direction in a chronological manner. By data which defines the moving distance and the moving direction, the three dimensional object which was placed at an initial position according to an instruction of the server 10, or an instruction of the user computer 20 is moved according to the motion control instruction such as for example, surprise and so on.

The partial region motion set data is of a structure in which an aggregation of predetermined coordinate values in the local coordinate system of the three dimensional object is extracted as the partial region, and each coordinate value in the partial region is extracted as the initial value, and by data which defines the each coordinate value by the displacement vector or affine transformation and soon, the three dimensional object is moved with the predetermined distance in the predetermined direction in a chronological manner according to the motion control instruction. Since each coordinate value of the predetermined partial region is moved in a chronological manner by the partial region motion set data, according to the motion control instruction of for example, surprise, in case that a human is set as the three dimensional object, it is possible to form fine and rich facial expressions, by setting a part or all of a face as the partial region.

Similarly, as to the partial region motion set data, for example, as shown in FIG. 3, it is possible to set up a set which directly corresponds or does not correspond to the shape set data, or the overall motion set data, for example, the partial region motion set data of an average Japanese person, the partial region motion set data of an average occupation G and so on. In addition, instead of extracting the coordinate value as a segmentation unit in the partial region, it is possible to extract a predetermined representative point or a group of coordinate values and to have the same moved in the same manner. Also, it may be configured that it is judged whether the coordinate value in the partial region falls within outer appearance data of the three dimensional object and only the coordinate value in the partial region in the outer appearance data is extracted and moved. Also, data relating to the partial region motion can be obtained by a three dimensional stereo television set and so on.

The motion control instruction data is data which controls motions of the three dimensional object, and individually controls each three dimensional object which a user set by the user computer 20 as an object. For example, according to the motion control instruction as shown in FIG. 5, motions of the three dimensional object which a user set at Object α are generated in such a manner that it smiles, is pleased and laughs, and motions of the three dimensional object which a user set at Object y are generated in such a manner that it is pleased at the same time of smiling. It is possible to send the motion control instruction data singly or continuously by control of the information providing program, and for example, it is possible to send it for example, in a scenario format for a predetermine period of time at predetermined intervals. Also, the motion control instruction data can set properly blush, hesitation, good feeling and others corresponding to the overall motion data and the partial region motion data.

In addition, it is possible to use the shape set data, the overall motion set data, the partial region motion set data and the motion control instruction data individually and separately, and it is possible to adopt a proper structure such as a structure that the shape set data and the overall motion set data are set, for example, in the user computer 20 and the server 10 transmits the partial region motion set data and the motion control instruction data one after another, or a structure that a server which transmits the motion control instruction is made to be a server which is different from the server 10, and the different server transmits the motion control instruction data with the scenario format and so on to the user computer 20, a structure that other data than the motion control instruction data is installed into the user computer 20, and so on.

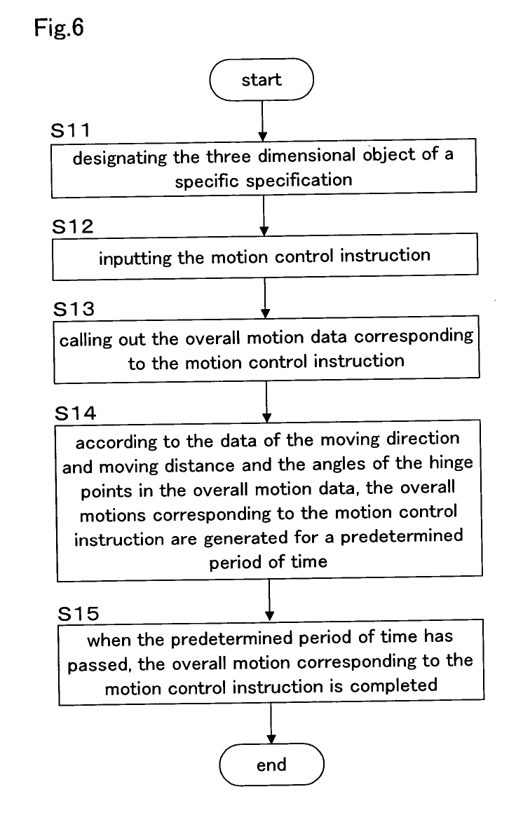

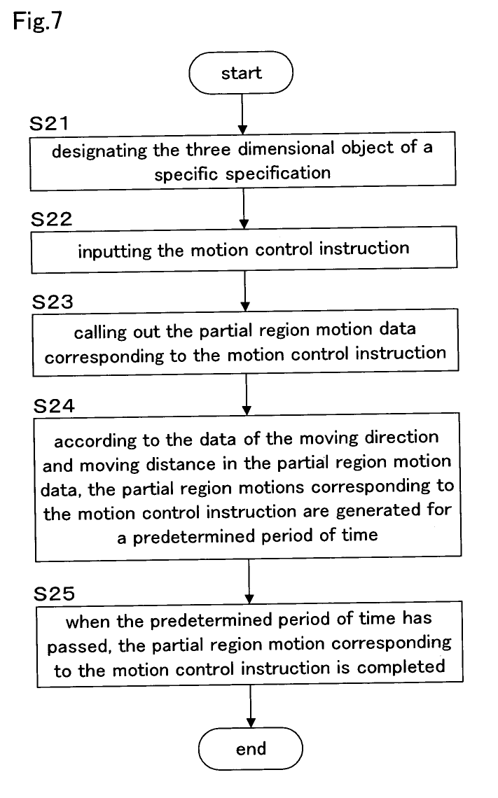

Next, a flow of processing which generates the overall motion and the partial region motion of the three dimensional object in the first embodiment will be described. FIG. 6 is a flow chart showing a flow of generating the overall motion in the first embodiment and FIG. 7 is a flow chart showing a flow of generating the partial region motion in the first embodiment.

On the occasion that the overall motion and the partial region motion are generated, as shown in FIGS. 6 and 7, firstly, a user designates the three dimensional object which is of a specific specification of a user and is moved according to the motion control instruction in the user computer 20 autonomously or in response to a request of the server 10, and displays the same on the image display unit 24 (S11, S21). On this occasion, in case that the motion control instruction includes a role of the three dimensional object, a plurality of each three dimensional object are to be designated with respect to each role. In addition, it is possible for the three dimensional object to freely move by drag and drop.

After the above-described designation, the motion control instruction which was transmitted from the server 10 through the Internet is inputted to the user computer 20 (S12, S22). In addition, this embodiment is of a case that the inputted motion control instruction is used in real time and motions of the three dimensional object are generated but, the motion control instruction is downloaded to the user computer 20 with a predetermined unit such as a predetermined time portion and by using the once stored motion control instruction, it is possible to generate the motions of the three dimensional object.

As to the overall motion, according to the motion control instruction, the overall motion data of the three dimensional object that the motion control instruction covers is called out (S13). For example, in case of an instruction for the motion control instruction to have Object a which is a human carry out a surprising motion, the overall motion data which corresponds to the surprise of Object a is called out. In response to this, according to the chronological definitions of the moving direction and moving distance of the three dimensional object and the angles of the hinge points of the three dimensional object in the overall motion data, the overall motions corresponding to the motion control instruction are generated for a predetermined period of time (S14). For example, in case of an instruction for having Object α which is a human carry out the surprising motion, physical motions when Object α was surprised are carry out during the predetermined period of time. And, when the predetermined period of time defined in the overall motion data has passed, the overall motion corresponding to the motion control instruction is completed (S15).

As to the partial region motion, according to the motion control instruction, the partial region motion data of the three dimensional object that the motion control instruction covers is called out (S23). For example, in case of an instruction for the motion control instruction to have Object α which is a human carry out a surprising motion, the partial region motion data which corresponds to the surprise of Object a is called out. In response to this, according to the chronological definitions of the moving direction and moving distance to the coordinate values in the predetermined region of the three dimensional object in the partial region motion data, each coordinate value is moved and the partial region motions corresponding to the motion control instruction are generated for a predetermined period of time (S24). For example, in case of an instruction for having Object α which is a human carry out the surprising motion, physical motions when Object α was surprised are carried out during the predetermined period of time. And, when the predetermined period of time defined in the partial region motion data has passed, the partial region motion corresponding to the motion control instruction is completed (S25). The overall motions and the partial region motions which were generated as above are displayed on the image display unit 24.

With regard to transmission of the motion control instruction data by the server 10, depending upon the predetermined time, the predetermined amount and so on of information which was transmitted to each user computer 20, information fee data is measured to be obtained, and by storing this in a information fee data file, on the basis of the information fee data, the information fee is charged to each user. Also, in the same manner, with regard to transmission of the shape set data, the overall motion set data, and the partial region motion set data, the information fee data may be stored and charged.

In addition, for example, by transmitting voice sound data corresponding to change of facial expressions of a face of Object α and a way of opening a mouse thereof, it is possible to have Object α which has fine and rich facial expressions carry out more real emotional expressions with voice sounds. Also, the motion control instruction data may be generated by converting voice sounds, and it is possible to transmit real time voice sounds as the motion control instruction data and to have the three dimensional object carry out the corresponding motions. Also, it may be configured that the motion control instruction data of the scenario format is made to be displayed on the image display unit 24.

The object providing system of the invention can provide an autonomic type object which has the code of conduct through information distribution by a network, and for example, it is possible to introduce information providing services on the Internet by the autonomic type object and so on, and also, it is possible to provide approximately the same video images as motion pictures by utilizing the motion generation of an object along a scenario. And, since it is possible to smoothly carry out change etc. of facial expressions of an object, without occurrence of switching of images, it is possible to realize sophisticated images of an artificial creature such as an electronic pet and an electronic idol.

Also, since it is possible to provide real time images of object motions by transmitting, for example, only the motion control instruction data, it is possible to reduce amount of data which is transmitted as much as possible, unlike a motion picture distribution, and it does not rely on an advanced communication infrastructure such as an optical fiber and so on and is effective.

Also, in the invention, it is possible to set different ways of being pleased with different overall motions and partial region motions with respect to each specific specification object of each user, to the same motion control instruction of “be pleased”. Furthermore, for example, the motion control instruction is set as “victory of a certain baseball team”, and data which corresponds to the above instruction is disposed in advance in the overall motion set data and the partial region motion set data, and thereby, it is possible to realize such a situation that an object of a certain user expresses pleasure, while an object of the other user express chagrin. Also, since it is possible for each user to individually set the three dimensional object with the specific specification by selecting from the shape set data, the overall motion set data and the partial region motion set data, it is possible to form a huge variety of virtual characters which meet preferences of users. Accordingly, it is possible to realize diversification and upgrading of communications on an electronic space.

Also, by utilizing the partial region motion set data of the invention for an object which has the existing physical motion function, it becomes possible also to form rich facial expressions on for example, the existing object which does not have the facial expression.

Also, in the invention, since it is possible to have an object carry out motions or composite motion independently, and it is possible to associate such object motions organically and freely by the motion control instruction and so on, it is possible to have an object and a group of objects carry out sophisticated expressions.

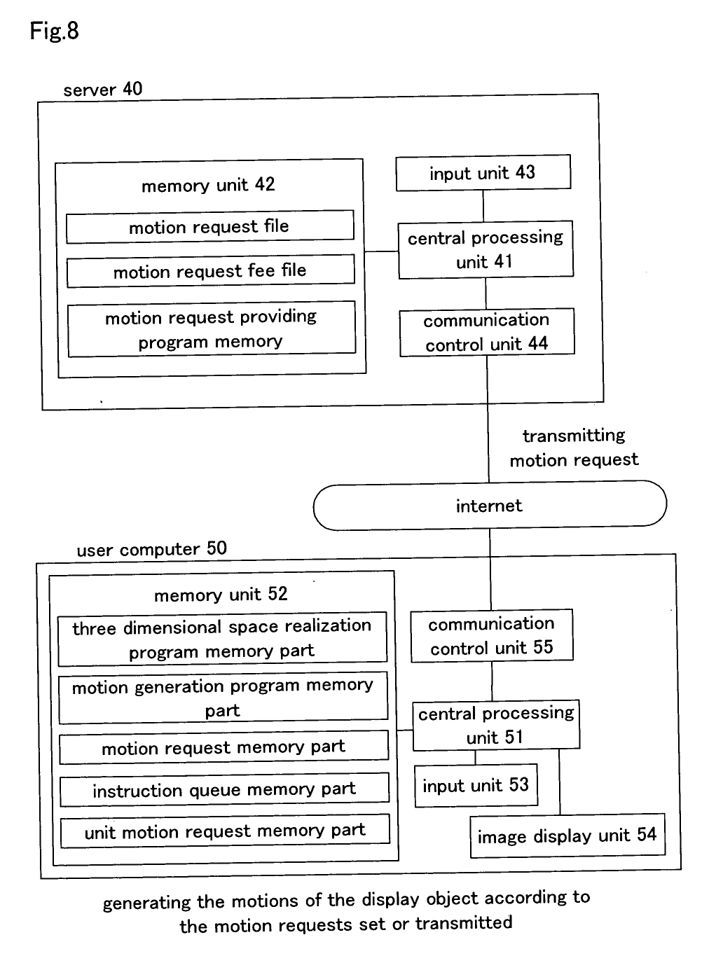

Next, a second embodiment of a providing system of a display object of the invention will be described. In addition, this invention includes one in which a necessary structure of the second embodiment or the first embodiment is added to the structure of the first embodiment or the second embodiment and one in which a necessary structure of the first embodiment or the second embodiment is substituted with a necessary structure of the second embodiment or the first embodiment. FIG. 8 is a block diagram showing a hardware structure of the second embodiment.

The providing system of the display object of the second embodiment is also one which provides a three dimensional display object, and its hardware structure is, as shown in FIG. 8, such that a server 40 and a user computer 50 are connected through the Internet, and the user computer 50 generates and display the three dimensional virtual space and the three dimensional object, and on the basis of motion requests which the server 40 provides to the user computer 50 through the Internet, and motion requests that the user computer 50 stores, motions of the three dimensional object are generated. In addition, in the same manner as in the first embodiment, it is at discretion to provide a network which connects the server 40 and the user computer 50.

In the server 40, in the same manner as in the first embodiment, a central processing unit 41, a memory unit 42, an input unit 43, and a communication control unit 44 are disposed by being connected, and the memory unit 42 is set, for example, in a scenario format in a chronological order. It has a motion request file for storing a plurality of motion requests which are data of motions generating the three dimensional object, a motion request fee file for storing fee data of motion requests that the server 40 provided to the user computer 50, and a motion request providing program memory part which stores a program for controlling overall processing for the server 40 to provide motion requests to the user computer 50, and besides them, it has necessary memory regions which store necessary data and so on. The above-described each data etc. can be added, deleted, changed and so on by the input unit 43.

In the user computer 50, in the same manner as in the first embodiment, a central processing unit 51, a memory unit 52, an input unit 53, an image display unit 54 and a communication control unit 55 are disposed by being connected, and as the user computer 50, besides personal computers or dedicated purpose computers, portable telephones, portable terminals and so on can be properly used, and also, it is possible to use a plurality of user computers 50 as a matter of course. In addition, each data etc. which is stored in the user computer 50 can be added, deleted, changed and so on by the input unit 53.

The memory unit 52 has a three dimensional space realization program memory part which stores data of the three dimensional virtual space and the three dimensional object in the three dimensional virtual space, a program of carrying out a control for generating the three dimensional virtual space and the three dimensional object and display the same on the image display unit 54, and data or program etc. which movably defines positions of the three dimensional object in the three dimensional virtual space. A system for movably defining the position of the three dimensional object in the three dimensional virtual space is arbitrary, for example, in such a manner that an entirety of the three dimensional virtual space is defined in a world coordinate system, and representative points of the three dimensional object such as an original point of a local coordinate system which defines the three dimensional object are defined, and the representative points of the three dimensional object are placed on arbitrary coordinate points of the world coordinate system and thereby, the three dimensional object is placed at a predetermined position, and by moving the representative points of the three dimensional object from the above-described arbitrary coordinate points to another arbitrary coordinate points, the three dimensional object is moved.

The data of the three dimensional object includes data for specifying the three dimensional object, and according to need, data of a motion structure of a predetermined three dimensional object and data of an outer appearance of the three dimensional object such as an outer shape, necessary patterns, colors and so on. If the motion structure of the three dimensional object is made to be of a structure that, as the skeleton structure where parts, that is, bone structures of each portions such as arms, a middle, legs and so on of an avatar are linked through the hinge points, moves by defining moving directions or paths and distances of the hinge points or by defining changing level of hinge angles by vectors and so on, and further, is made to be of a structure that moves, by defining setting points such as a lot of extraction points or a lot of hinge points and so on, which set the predetermined coordinate points of the local coordinate system as an initial coordinate at a part or all of predetermined regions of the three dimensional object such as all or a part of a face of the avatar, and by defining moving directions or paths and distances of the setting points or by defining changing level of angles by vectors and so on, it becomes possible to generate, for example, fine and rich facial expressions of the avatar and complicated motions of the three dimensional object, which is desirable.

In addition, it is possible to properly use another motion structure than that of this embodiment as the motion structure of the three dimensional object. Also, the data of the outer appearance of the three dimensional object sets polygon data and so on by curve lines and curve surfaces at the setting points such as the extraction points and the hinge points, and to this, a necessary outer appearance, patterns, colors etc. such as images etc. of a face and clothes were attached by the texture mapping. Also, the three dimensional object is not limited to the avatar but is arbitrary if it can be displayed in the three dimensional virtual space. Also, as the structure that the three dimensional virtual space and the three dimensional display object are generated and displayed by a cooperation of hardware and software, and motions of the three dimensional display object can be generated, another structure than that in the embodiment can be properly used. Also, it may be configured that the data of the three dimensional object is, in the same manner as in the first embodiment, transmitted from the server 40 to the user computer 50 according to need, and the data of the three dimensional object which is stored in the user computer 50 is added or changed, and the specific specification three dimensional object of a user can be set.

Also, the memory unit 52 has a motion generation program memory part which stores a motion generation program for carrying out a control of a whole of motion generation of the three dimensional object in cooperation with the hardware, a motion request memory part which stores a plurality of motion requests that are motion data which the three dimensional object generates, for example, being set in a scenario format in a chronological manner, an instruction queue memory part in which motion requests to be executed in parallel and motion requests to be executed sequentially are once stored in a classified manner, and a unit motion request memory part in which once stored are unit motion requests which were prepared by dividing the motion request into unit time portions. Furthermore, the memory unit 52 has a necessary memory region which stores data etc. necessary for generating the motions of the three dimensional object in the three dimensional virtual space of this embodiment.

By the above-described hardware structure, it is configured that the central processing unit 51 of the user computer 50 collaborates with the program which is stored in the memory unit 52, and generates the three dimensional virtual space and the three dimensional object and displays the same on the image display unit 54, and according to the motion request which is set in the motion request memory part, or according to the motion request which is transmitted from the server 40, generates the motions of the three dimensional object and displays the motions of the generated three dimensional object on the image display unit 54. These generations and displays can be timely initiated according to an input from the input unit 53, and also, by the input units 43 and 53, it is possible to properly change, update and so on the motion requests etc. which are set in the motion request file of the server 40 and the motion request memory part of the user computer 50.

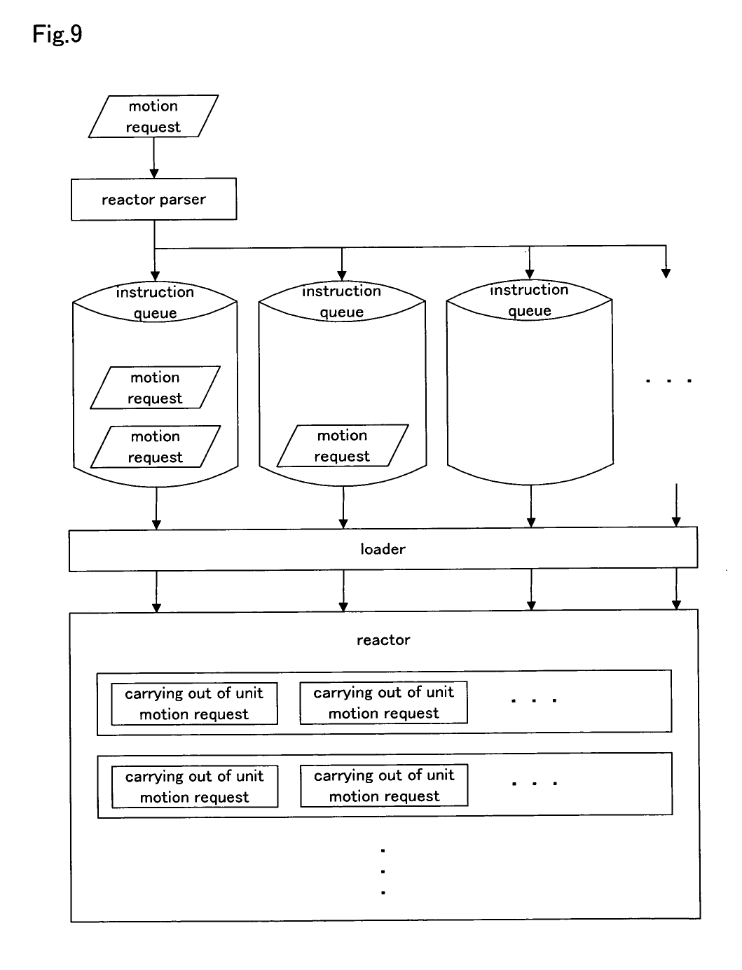

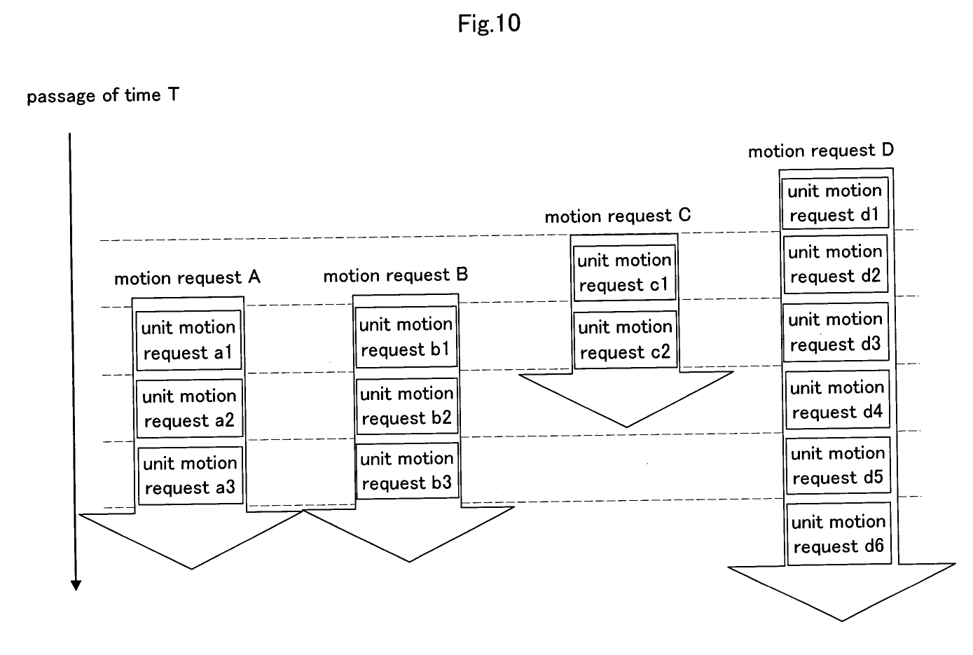

Next, in the providing system of the display object of the second embodiment, processing for generating motions of the three dimensional object by the user computer 50 will be described. FIG. 9 is an illustration illustrating processing for generating motions of the three dimensional object, and FIG. 10 is an illustration illustrating a flow for carrying out motion requests.

In the processing for generating the motions of the three dimensional object by the user computer 50, as shown in FIG. 9, firstly, the central processing unit 51 which collaborates with the motion generation program reads out and recognizes the motion requests from the motion request memory part in a chronological manner, or takes in and recognizes the motion requests which were transmitted from the server 40, and the central processing unit 51 functions as a reactor parser, and fractionates the recognized motion request into each instruction queue of an instruction queue memory part and stores the same. The motion request is one which has motion object data of the three dimensional object for generating the motions and motion content data of the motion object and motion time for generating the motions.

The reactor parser, in case that it recognized a plurality of motion requests or motion request groups which are set by being successively aligned without having additional information or the motion requests and the motion request groups, and in case that it recognized a plurality of motion requests or motion request groups which are set sequentially or the motion requests and the motion request groups, once stores these plurality of the motion requests or the motion request groups or the motion requests and the motion request groups in separate instruction queues as the motion request or the motion request group of parallel processing or the motion request and the motion request group, and also, in case that it recognized the motion request group having a plurality of motion requests to which information to be processed sequentially is added and which are aligned successively and set, once stores a plurality of the motion requests in the same instruction queue in a order of the alignment thereof. In addition, it is configured that executions of first unit motion requests of a plurality of respective motion requests or motion request groups which are set by being successively aligned without having additional information or the motion requests and the motion request groups are carried out at the same time and in parallel. Also, it is possible to properly carry out setting of the additional information of the motion request group, in addition to setting of sequential processing, such as, for example, to set it to one which is parallel-processed, to set it to both of one which is parallel-processed and one which is serial-processed, to set other processing, and so on.

The motion requests which were stored in the instruction queue are taken in a reactor through a loader. The reactor comprises the central processing unit 51 which mainly collaborates with the motion generation program and the unit motion request memory part. The reactor is of such a structure that, to the motion requests which are stored in the same instruction queue in a sequential order, it takes in a head motion request and finishes motion generation for its motion time, and takes in a motion request of a next order and generates motions for its motion time, and also, takes in motion requests which are stored in separate instruction queues independently.

The reactor is configured to carry out one processing with respect to each unit time such as 0.1 second, and divides the motion requests for a predetermined motion time portion which were taken in into motion requests for the unit time portion and generates unit time requests, and on the basis of the motion object data of the motion requests or the unit motion requests, to specify and recognize a motion object of the three dimensional object which is an object for motion generation and is set, and to execute sequentially the unit motion requests for its motion time portion and thereby, to generates motions of the motion time and the motion content of the motion request to the motion object which is the object. In this case, in case that there are unit motion requests which were generated by dividing the motion requests which were stored in one or a plurality of separate instruction queues in the same manner, a unit motion request which was generated from the motion request stored in one instruction queue and a unit motion request which was generated from the motion request stored in another instruction queue are executed at one processing with respect to each unit time of the reactor at the same time and in parallel, and motions of a plurality of unit motion requests are generated at the same time and in parallel.

By the structure for carrying out a plurality of the unit motion requests in parallel, for example, as shown in FIG. 10, unit motion requests a1˜a3, b1˜b3 of motion requests A, B having motion time for 3 unit time portions, unit motion requests c1˜c2 of a motion request C having motion time for 2 unit time portions, and unit motion requests d1˜d6 of a motion request D having motion time for 6 unit time portions are executed in a sequential order, respectively, and all or a part of the unit motion requests of each motion request are executed at the same time and in parallel. In this embodiment, execution of respective unit motion requests is initiated in a order of the motion request D, the motion request C, the motion requests A and B, and the unit motion request c2 as well as the unit motion request d2 are executed at the same time and in parallel, and the unit motion requests a1, b1 as well as the unit motion requests d2, c2 are executed at the same time and in parallel. After that, the unit motion requests a2, b2, d4 are executed at the same time and in parallel, and the unit motion requests a3, b3, d5 are executed at the same time and in parallel, and after the motion generation of the motion requests A, B was completed, the unit motion request d6 is executed independently.

As described above, it is of a structure that complicated and a huge variety of motions can be generated in such a manner that, by executing the unit motion request of the motion request and the unit motion request of another motion request in parallel, a plurality of motions of the display object are generated independently and in parallel, or, motions of a plurality of display objects are generated independently and in parallel, or generation of one motion is continued while generation of other motion is initiated with time difference and both motions are executed in parallel, and so on.

In addition, it is possible to set the motion object of the motion request properly at the representative points which define a whole or a portion of the three dimensional object such as the original point etc. of the local coordinate system, the setting points such as the hinge points and the extraction points etc. of the skeleton structure, the representative region which defines a whole or a portion, and so on, and it may be configured that, for example, by designating the object such as a face, a head and so on as the motion object of the motion request, by extracting the representative points etc. of the motion object according to designation of its motion object, and by generating motions of its representative point etc., the motions of the motion object or the three dimensional object are generated. Also, it is possible to set same or different motion objects by a plurality of motion requests, a whole or a part of which are executed at the same time and in parallel. In case that the same motion objects are set by a plurality of the motion requests which are executed in parallel, by executing respective unit motion requests of a plurality of the motion requests at the same time and in parallel to the same motion objects, it is possible to generate the motions of the motion contents of each motion request by combining or to the same motion objects.

Also, the motion contents of the motion requests are properly set to be for example, movement to a predetermined point, rotation to a predetermined point, movement in a predetermined direction with a predetermined distance, rotation of a predetermined angle in a predetermined direction, movement of a predetermined distance along a curved line which is defined by various formulas, and soon, and its way of defining is properly set according to the way of defining the three dimensional virtual space and the three dimensional object, in such a manner that a position of the motion object before the execution of the unit motion request of the motion request of the display object is set at an initial value and the motions of the motion object are generated by relatively defining the motion amount to the initial value and according to need, paths or directions of the motions, or the motions of the motion object are generated by defining a final absolute position to which the motion object is moved and according to need, the paths or the directions of the motions, to define by vector expressions such as for example, displacement vectors, affine transformation etc., and so on. Also, the motion content of the motion request is properly set to be, for example, ordinary motion or independent motion, compound motion which is a set of motions, and so on.

Also, in addition to the motion request, or asides from the motion request, it may be configured to transmit or set data for managing a state at the time of motion generation etc. of the display object to manage the state of the display object. Also, aside from the structure for generating the motions in parallel, a structure for generating the motions according to the motion requests may be disposed.

Also, it is possible to properly set the motion time of the motion request which is required for the motion of the three dimensional object, the unit time of the unit time request or unit time of one time processing of the reactor at arbitrary time. Also, the motions which are generated includes a partial motion such as change of a facial expression of the three dimensional object, the overall motion such as physical motion of a human body, rotation of the three dimensional object and movement between spots, and so on. Also, the motion generation processing may be directed to other display object such as two dimension than the three dimensional object.

Also, it is possible to make each motion object, each motion content, and each motion time of one motion request and another motion request to be the same or different motion object, the same or different motion content, and the same or different motion time, respectively, and also, it is possible to make the another motion request to be one or a plurality of requests. Also, the number of necessary times for executing the unit motion request and another unit motion request in parallel and at the same time is determined by the motion time of each motion request and execution start time of the unit motion request of each motion request and so on, and is 0 time, one time or a plurality of times etc., and for example, in case that motion time of the motion request and motion time of another motion request are the same and executions of respective unit motion requests are initiated at the same time, the unit motion request of the motion request and the unit motion request of another motion request are executed in parallel and at the same time, and the simultaneous parallel execution is repeated the same number of times and finished at the same time.

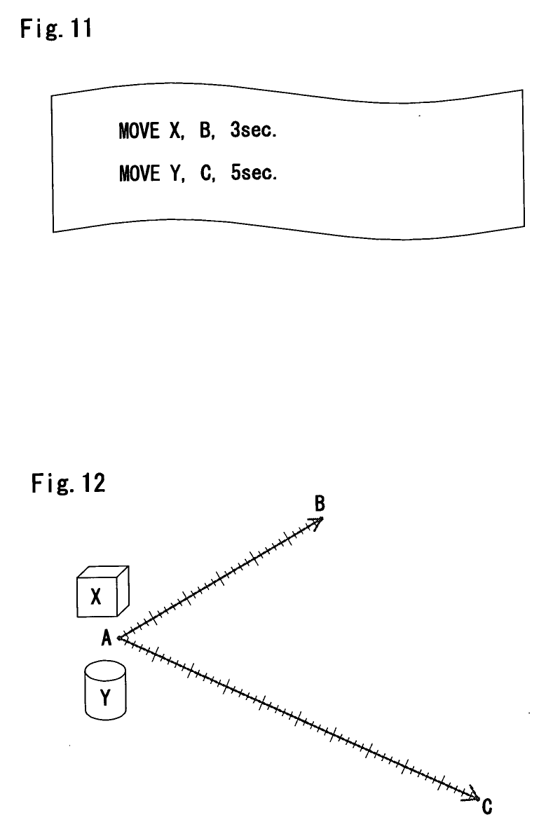

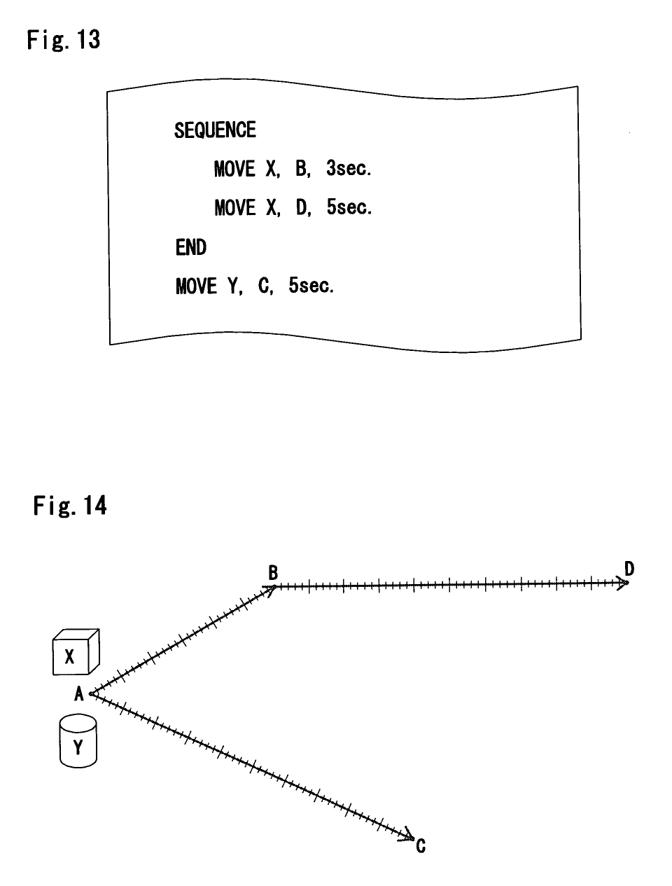

Here, a case of processing concrete examples of the motion request by the user computer 50 to generate motions of the three dimensional object will be described. FIGS. 11 and 13 are views showing motion request of a first example and a second example, respectively, and FIGS. 12 and 14 are illustrations illustrating motions which are generated according to the first example and the second example.

The first example is a case in which a motion request for moving a representative point X of a three dimensional object X which is positioned at a point A in a three dimensional virtual space to a point B with taking motion time of 3 seconds, and a motion request for moving a representative point Y of a three dimensional object Y which is positioned at the point A in the three dimensional virtual space to a point C with taking motion time of 5 seconds are initiated and executed at the same time and in parallel. In motion requests (MOVE X, B, 3 sec), (MOVE Y, C, 5 sec) shown in FIG. 11, X, Y represent motion objects, and MOVE and B, C represent motion contents, and B, C are, for example, a displacement vector AB and a displacement vector AC, and 3 sec, 5 sec represent motion time. The two motion requests which are aligned consecutively without the additional information are taken in the reactor by the reactor parser after they are classified and stored into separate instruction queues.

After that, in the reactor, as to the motion requests (MOVE X, B, 3 sec), (MOVE Y, C, 5 sec), for example, the unit motion requests for unit time of 0.1 second are generated by dividing the motion request, and each unit motion request which was generated is stored in the unit motion request memory part in a order of execution. Since the motion time of the former motion request is 3 seconds, thirty unit motion requests are to be generated, and since the motion time of the latter motion request is 5 seconds, fifty unit motion requests are to be generated.

And, the reactor starts the executions of a first unit motion request of the motion request (MOVE X, B, 3 sec) and a first unit motion request of the motion request (MOVE Y, C, 5 sec) at the same time and in parallel, and until the completion of the executions of the thirty unit motion requests of the former motion request which has shorter motion time, it execute each unit motion request of the motion request (MOVE X, B, 3 sec) and each unit motion request of the motion request (MOVE Y, C, 5 sec) at the same time and in parallel. After the executions of the thirty unit motion requests of the former motion request were completed, the remaining twenty unit motion requests of the latter motion request are executed independently.

By the executions of each unit motion request of the motion request (MOVE X, B, 3 sec) and each unit motion request of the motion request (MOVE Y, C, 5 sec), as shown in FIG. 12, generated is such a motion that the three dimensional object X or its representative point X is moved from the point A to the point B with taking three seconds, and the three dimensional object Y or its representative point Y is moved from the point A to the point C with taking five seconds. Scales between AB and between AC indicate a moving distance with respect to each unit time by the execution of each unit motion request, and by the execution of each unit motion request, one scale portion movement in a direction of AB or in a direction of AC is carried out. In this example, on the occasion of completion of the movement of the three dimensional object X or its representative point X from the point A to the point B, the movement of the three dimensional object Y or its representative point Y from the point A to the point C is on the way, and movement for remaining motion time of 2 seconds is thereafter generated.

Also, the second example is a case in which a motion request for moving the representative point X of the three dimensional object X which is positioned at the point A in the three dimensional virtual space to the point B with taking motion time of 3 seconds and a motion request for moving the representative point X of the three dimensional object X after it was moved to the point B to a point D with taking motion time of 5 seconds, and a motion request for moving the representative point Y of the three dimensional object Y which is positioned at the point A in the three dimensional virtual space to the point C with taking motion time of 5 seconds are initiated and executed at the same time and in parallel.

In the motion requests (MOVE X, B, 3 sec), (MOVE X, D, 5 sec), (MOVE Y, C, 5 sec) shown in FIG. 13, X, Y represent motion objects, and MOVE and B, D, C represent motion contents, and B, D, C are, for example, a displacement vector AB, BD and a displacement vector AC, and 3 sec, 5 sec represent motion time. Furthermore, SEQUENCE represents additional data of sequential processing, and a group of motion requests which are sandwiched between SEQUENCE and END and consecutively aligned are to be processed in sequence from a superior motion request, and also, the group of the motion requests which are consecutively aligned and the motion request (MOVE Y, C, 5 sec) are to be processed in parallel. The motion requests (MOVE X, B, 3 sec), (MOVE X, D, 5 sec) are stored in the same instruction queue in this order by the reactor parser, and the reactor, after it took in the motion request (MOVE X, B, 3 sec) and executed the same, takes in the motion request (MOVE X, D, 5 sec) and executes the same. Also, the motion request (MOVE Y, C, 5 sec) is classified and stored in another instruction queue which is different from the instruction queue which stored the motion requests (MOVE X, B, 3 sec), (MOVE X, D, 5 sec), and after that, taken in the reactor.

The reactor, in the same manner as the case of the above-described first example, takes in the motion request (MOVE X, B, 3 sec) and the motion request (MOVE Y, C, 5 sec) and, as to the respective motion requests (MOVE X, B, 3 sec), (MOVE Y, C, 5 sec), for example, the unit motion requests for unit time of 0.1 second are generated by dividing the motion request, and each unit motion request which was generated is stored in the unit motion request memory part in a order of execution. Since the motion time of the former motion request is 3 seconds, thirty unit motion requests are to be generated, and since the motion time of the latter motion request is 5 seconds, fifty unit motion requests are to be generated.

And, it starts the executions of a first unit motion request of the motion request (MOVE X, B, 3 sec) and a first unit motion request of the motion request (MOVE Y, C, 5 sec) at the same time and in parallel, and until the completion of the executions of the thirty unit motion requests of the former motion request which has shorter motion time, it executes each unit motion request of the motion request (MOVE X, B, 3 sec) and each unit motion request of the motion request (MOVE Y, C, 5 sec) at the same time and in parallel. After that, the reactor takes in the motion request (MOVE X, C, 5 sec) from the same instruction queue as the instruction queue in which the motion request (MOVE X, B, 3 sec) was stored upon completion of the execution of the unit motion requests of the motion request (MOVEX, B, 3 sec), and in the same manner, it generates and stores fifty unit motion requests for 5 seconds, and by execution processing of the reactor which is next to the execution processing which executed a last unit motion request of the motion request (MOVE X, B, 3 sec), it executes the first unit motion request of the motion request (MOVE X, D, 5 sec). After that, respective twenty unit motion requests of the motion request (MOVE X, D, 5 sec) and respective twenty unit motion requests of the motion request (MOVE Y, C, 5 sec) are executed at the same time and in parallel, respectively, and after the executions of the unit motion requests of the motion request (MOVE Y, C, 5 sec) was completed, remaining thirty unit motion requests of the motion request (MOVE X, D, 5 sec) are executed independently.

By the executions of each unit motion request of the above-described motion requests, as shown in FIG. 14, generated is such a motion that the three dimensional object X or its representative point X is moved from the point A to the point B with taking 3 seconds and thereafter, moved from the point B to the point D with taking 5 seconds, and the three dimensional object Y or its representative point Y is moved from the point A to the point C with taking five seconds. In the same manner as in the above-described first example, scales between AB, between BD and between AC indicate a moving distance with respect to each unit time by the execution of each unit motion request, and by the execution of each unit motion request, one scale portion movement in a direction of AB, in a direction of BD or in a direction of AC is carried out. In this example, on the occasion of completion of the movement of the three dimensional object Y or its representative point Y from the point A to the point C, the movement of the three dimensional object X or its representative point X from the point A to the point B is on the way, and movement for remaining motion time of 3 seconds is thereafter generated.

What is claimed is:

1. A providing system of a display object which is displayed on an image display unit by use of a computer or a computer network, wherein, aside from a control for generating an overall motion of the display object, a partial region in the display object is extracted and, in the partial region, a plurality of segmentation units are extracted, and, in response to a motion control instruction, each of the necessary segmentation units is moved based upon time lapse, and thereby, motion generation of the partial region is controlled.

2. The providing system of the display object as set forth in claim 1, wherein, stored are plural kinds of shape set data which defines at least a structure and an outer appearance in which the display object can be moved, plural kinds of overall motions set data which is generated by a predetermined value that defined the overall motion of the display object in a chronological manner, and plural kinds of partial region motion set data which is generated by a predetermined value that defined the partial region motion of the display object in a chronological manner, and stored is at least one of a specific specification display object which comprises a combination of an extracted one of the shape set data, an extracted one of the overall motion set data and an extracted one of the partial region motion set data, and in response to a motion control instruction, a predetermined motion in the overall motion set data of the specific specification display object or in the partial region motion set data thereof or in both of them is extracted to be executed, and the motion of the specific specification display object is generated.

3. The providing system of the display object as set forth in claim 1 or 2, wherein the motion control instruction is transmitted through a transmission medium.

4. A providing system of a display object which is displayed in an image display unit by use of a computer network, wherein, a server stores plural kinds of shape set data which defines at least a structure and an outer appearance in which the display object can be moved, plural kinds of overall motions set data which is generated by a predetermined value that defined the overall motion of the display object in a chronological manner, and plural kinds of partial region motion set data which is generated by a predetermined value that defined the partial region motion of the display object in a chronological manner, and urges to download one or a plurality of the shape set data, one or a plurality of the overall motion set data, and one or a plurality of the partial region motion set data.

5. The providing system of the display object as set forth in claim 4, wherein the server urges to set the display object with a specific specification which comprises a combination one of the shape set data, one of the overall motion set data, and one of the partial region motion set data.

6. A providing system of a display object which is displayed in an image display unit by use of a computer network, wherein a server transmits a motion control instruction to the specific specification display object of a user computer which comprises a combination of the shape set data which defines at least a structure and an outer appearance in which the display object can be moved, the overall motions set data which is generated by a predetermined value that defined the overall motion of the display object in a chronological manner, and the partial region motion set data which is generated by a predetermined value that defined the partial region motion of the display object in a chronological manner.

7. The providing system of the display object as set forth in claim 6, wherein a server transmits a motion control instruction continuously or a continuous motion control instruction to a user computer which carries out processing in response to a motion control instruction, which generate real time motion of the specific specification object.

8. The providing system of the display object as set forth in claim 6 or 7, wherein, to the user computer which stored a program for generating a plurality of motions of the specific specification display object in parallel, the server transmits the motion control instruction which generates a plurality of motions in parallel by designating the specific specification display object which should be moved.

9. The providing system of the display object as set forth in claim 6, 7, or 8, wherein, to the user computer which stored a program for independently generating a plurality of motions of the specific specification display object, the server transmits the motion control instruction which generates the motions by designating a plurality of the specific specification display objects which should be moved.

10. The providing system of the display object as set forth in claim 4, 5, 6, 7, 8 or 9, wherein the server measures and stores information fee data to predetermined information which was transmitted to each user computer.

11. A program for providing a display object which is displayed in an image display unit by use of a computer or a computer network, wherein, aside from a control for generating an overall motion of the display object, a partial region in the display object is extracted and, in the partial region, a plurality of segmentation units are extracted, and, in response to a motion control instruction, each of the necessary segmentation units is moved based upon time lapse, and thereby, motion generation of the partial region is controlled.

12. A program for providing a display object which is displayed in an image display unit by use of a computer or a computer network, wherein, to a specific specification display object which comprises shape set data which defines at least a structure and an outer appearance in which the display object can be moved, overall motions set data which is generated by a predetermined value that defined the overall motion of the display object in a chronological manner, and partial region motion set data which is generated by a predetermined value that defined the partial region motion of the display object in a chronological manner, and, in response to a motion control instruction, a predetermined motion in the overall motion set data of the specific specification display object or in the partial region motion set data thereof or in both of them is extracted to be executed, and the motion of the specific specification display object is generated.

13. A providing system of a display object by generating motions of the display object which is displayed on an image display unit by use of a computer network, wherein, to a user computer having a unit adapted to generate unit motion requests which are comparable to unit time portion of motions of the motion request on the basis of a motion object of the display object which is set and a motion request having a motion content and motion time, and to recognize the motion-object, and to execute the unit motion request for the motion time portion to generate the motions of the motion object, at least a server transmits the motion request.

14. The providing system of the display object as set forth in claim 13, wherein, by generating another unit motion request based upon another motion request having another motion object and another motion content and another motion time and by recognizing the another motion object and by executing the another unit motion request the number of predetermined times in parallel with the unit motion request at the same time, to the user computer having the unit adapted to execute the another unit motion request for another motion time portion to generate motions of the another motion object, at least the server transmits the motion request.

15. The providing system of the display object as set forth in claim 14, wherein, on the basis of a plurality of motion requests to which information being capable to distinguish parallel processing and sequential processing is added according to need, to the above-described user computer having a unit adapted to process each motion request in parallel in case of a plurality of the motion requests of parallel processing, and to process each motion request sequentially in case of a plurality of motion requests of sequential processing, at least the above-described server transmits a plurality of the motion requests.

16. The providing system of the display object as set forth in claim 13, 14, or 15, wherein the server transmits the motion request to the user computer having a unit adapted to store the motion requests, and in addition to generating the motion of the motion object on the basis of the motion request to be stored, generated is a motion of the motion object on the basis of the motion request to be transmitted.

17. The providing system of the display object as set forth in claim 13, 14, 15 or 16, wherein the server transmits data of the display object according to a transmission request to the user computer.

18. A providing system of a display object by generating motions of the display object which is displayed on an image display unit by use of a computer network, wherein, to a user computer having a unit adapted to generate motions of the display object which is set, on the basis of motion data, a server transmits motion data, and in addition to motion generation on the basis of the motion data which is set in the user computer, motion generation of the display object based upon the motion data to be transmitted is provided.

19. A providing system of a display object by generating motions of the display object which is displayed on an image display unit and whose motions are generated by use of a computer network, wherein, to a user computer having a unit adapted to store the display object which is set, and to generate a unit motion request which is comparable to a unit time portion of the motion of a motion object on the basis of a motion request having a motion object of the display object and a motion content and motion time of the motion object, and to recognize the motion object and to execute the unit motion request by the motion time portion to generate the motion of the motion object, at least a server transmits a part or all of data of the display object.
